(19) United States
(12) Patent Application Publication
(10) Pub. No.: US 2026/0030136 A1
(43) Pub. Date: Jan. 29, 2026

(54) PROACTIVE ERROR RESOLUTION FOR AN EXECUTING JOB

(71) Applicant: Capital One Services, LLC, McLean, VA (US)

(72) Inventors: Yogesh KALE, Aldie, VA (US); Jared RONNING, Washington, DC (US); Arden QIU, Parkville, MD (US); Mihir SHAH, Glen Allen, VA (US); Cosette GOLDSTEIN, Arlington, VA (US); Glen RUCKER, Mechanicsville, VA (US); HanYi JIANG, Katy, TX (US); Uday JAIN, Glen Allen, VA (US)

(21) Appl. No.: 18/785,039

(22) Filed: Jul. 26, 2024

(51) Int. Cl. G06F 11/36

(52) U.S. Cl. CPC G06F 11/3608

(57) ABSTRACT

In some implementations, a device may obtain one or more logs that relate an execution of a job in a platform. The log(s) may be generated by the platform, the platform may use one or more computing systems in connection with the execution of the job, and the job may be user-initiated. The device may process the log(s) to identify whether an entry in the log(s) indicates an error event for the job. The device may determine a resolution output relating to the error event. The device may obtain incident data that relates to the computing system(s), where the incident data indicates whether an incident impacting the computing system(s) has been detected. The device may generate a communication that may include at least one of the resolution output or an incident output relating to the incident, in accordance with whether the incident data indicates the incident.

### BACKGROUND

Software development projects may be completed by distributed teams of dozens, hundreds, or even thousands of developers. Each team may perform development activities, such as coding, quality control checking, code deployment, or the like. Each software development project may include numerous code files that are modified frequently.

### SUMMARY

Some implementations described herein relate to a system for proactive error resolution. The system may include one or more memories and one or more processors communicatively coupled to the one or more memories. The one or more processors may be configured to obtain one or more logs that relate to a build process for an application in a continuous integration/continuous deployment (CI/CD) platform, where the one or more logs are generated by the CI/CD platform, the CI/CD platform uses one or more computing systems in connection with the build process, and the build process is user-initiated by a user. The one or more processors may be configured to process the one or more logs to identify whether an entry in the one or more logs indicates an error event for the build process. The one or more processors may be configured to input, responsive to identification of the entry indicating the error event, context information to a machine learning language model to obtain a resolution output, where the context information includes the one or more logs and event information derived from the entry. The one or more processors may be configured to obtain, from an incident tracking system and responsive to identification of the entry indicating the error event, incident data that relates to the one or more computing systems, where the incident data indicates whether an incident impacting the one or more computing systems has been detected. The one or more processors may be configured to generate a communication that is for the user, where the communication includes at least one of the resolution output or an incident output relating to the incident, in accordance with whether the incident data indicates the incident.

Some implementations described herein relate to a method of proactive error resolution. The method may include obtaining, responsive to an execution of a job in a platform, one or more logs that relate to the execution of the job, where the one or more logs are generated by the platform, and the platform uses one or more computing systems in connection with the execution of the job. The method may include processing the one or more logs to identify whether an entry in the one or more logs indicates an error event for the job. The method may include determining, responsive to identification of the entry indicating the error event, a resolution output relating to the error event. The method may include obtaining, from an incident tracking system, incident data that relates to the one or more computing systems, where the incident data indicates whether an incident impacting the one or more computing systems has been detected. The method may include generating a communication that includes at least one of the resolution output or an incident output relating to the incident, in accordance with whether the incident data indicates the incident.

Some implementations described herein relate to a non-transitory computer-readable medium that stores a set of instructions for proactive error resolution. The set of instructions, when executed by one or more processors of a device, may cause the device to obtain one or more logs that relate to an execution of a job in a platform, where the one or more logs are generated by the platform, the platform uses one or more computing systems in connection with the execution of the job, and the job is user-initiated by a user. The set of instructions, when executed by the one or more processors, may cause the device to process the one or more logs to identify whether an entry in the one or more logs indicates an error event for the job. The set of instructions, when executed by the one or more processors, may cause the device to input, responsive to identification of the entry indicating the error event, context information to a machine learning language model to obtain a resolution output, where the context information includes event information derived from the entry. The set of instructions, when executed by the one or more processors, may cause the device to generate a communication that includes the resolution output. The set of instructions, when executed by the one or more processors, may cause the device to transmit the communication for delivery to the user by at least one of a chat message, a text message, an email message, or an automated phone call.

### BRIEF DESCRIPTION OF THE DRAWINGS

FIGS. 1A-1D are diagrams of an example associated with proactive error resolution for an executing job, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with proactive error resolution for an executing job, in accordance with some embodiments of the present disclosure.

FIG. 4 is a flowchart of an example process associated with proactive error resolution for an executing job, in accordance with some embodiments of the present disclosure.

### DETAILED DESCRIPTION

The following detailed description of example implementations refers to the accompanying drawings. The same reference numbers in different drawings may identify the same or similar elements.

A user may initiate an execution of a job on a platform. For example, the platform may be a continuous integration/continuous deployment (CI/CD) platform, and the job may be a build process for an application. In some cases, one or more error events arising during the execution of the job may prevent proper execution of the job and/or may result in failure of the job. In such cases, the user may seek technical support to find a resolution for the error events. For example, using a user device, the user may gather data relating to the error events and provide the data to a support device associated with support personnel. Furthermore, the user or support personnel may initiate a support session between the user device and the support device to engage in error diagnosis and/or troubleshooting. This process is inefficient, time consuming, and involves excessive back-and-forth communication between the user device and the support device, thereby consuming excessive computing resources (e.g., memory resources and/or processor resources associated with user devices and/or support devices) and/or network resources.

Some implementations described herein enable proactive error resolution for an executing job. In some implementations, while execution of a job is ongoing in a platform, a resolution system may monitor logs generated by the platform in real time. The resolution system may identify an error event in one or more entries of the log, thereby indicating that a user associated with the job may be in need of technical support. Accordingly, the resolution system may proactively (e.g., without the user requesting support) analyze the error event, determine a resolution for the error event, and generate a communication for the user that indicates the resolution. In some implementations, the resolution system may also monitor for incidents (e.g., production incidents) associated with systems that are used by the platform while executing the job (e.g., one or more cloud computing systems, one or more version control systems, or the like). Accordingly, the resolution system may proactively (e.g., without the user requesting support) generate a communication for the user that indicates the incident.

By proactively notifying the user of a resolution for the error event and/or of a broader incident that would make resolution attempts futile, the resolution system conserves computing resources and/or network resources that would otherwise be used in connection with a lengthy and inefficient support session between the user device and a support device to engage in error diagnosis and/or troubleshooting. Moreover, by proactively notifying the user of a resolution for the error event, the resolution system enables errors to be resolved faster and more efficiently, thereby improving the performance of an execution of the job, improving an availability or uptime of services or systems relating to the job, and/or conserving computing resources of a system that implements the platform (e.g., by reducing a number of attempts to execute the job and/or reducing troubleshooting operations).

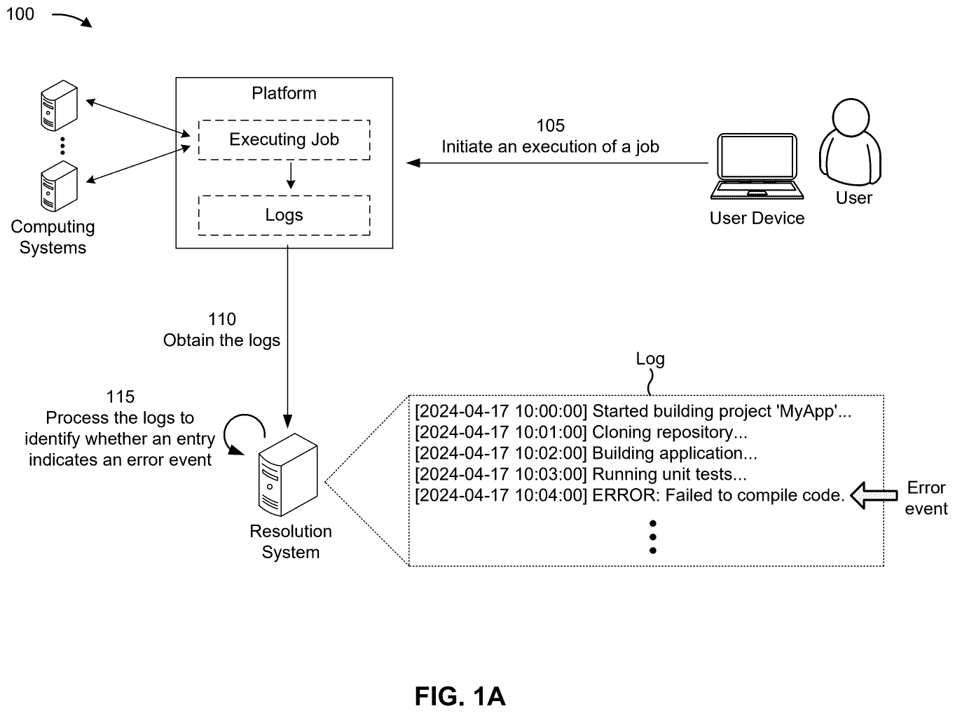

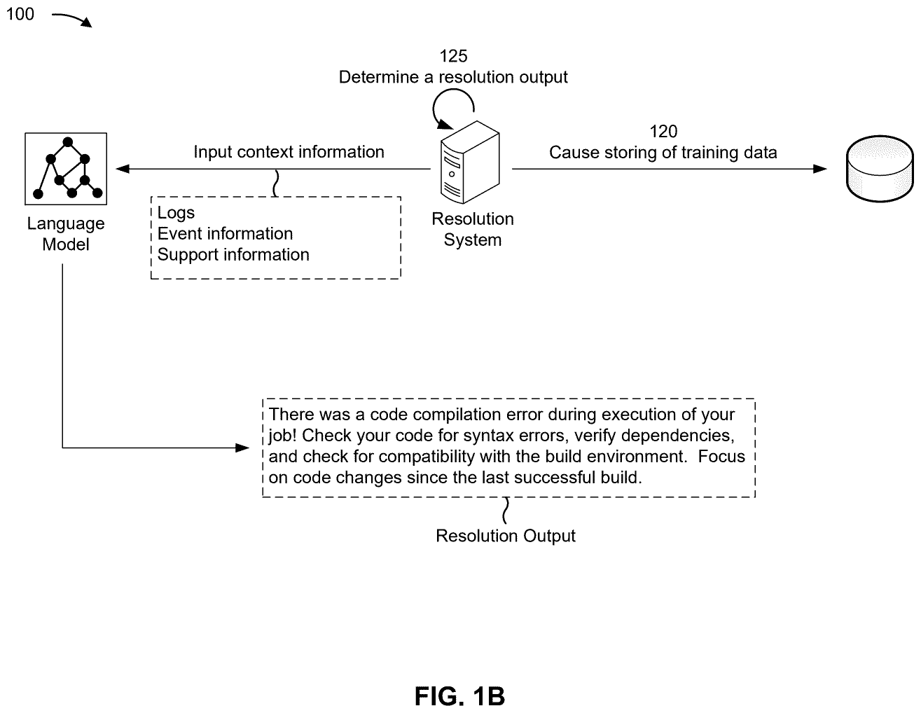

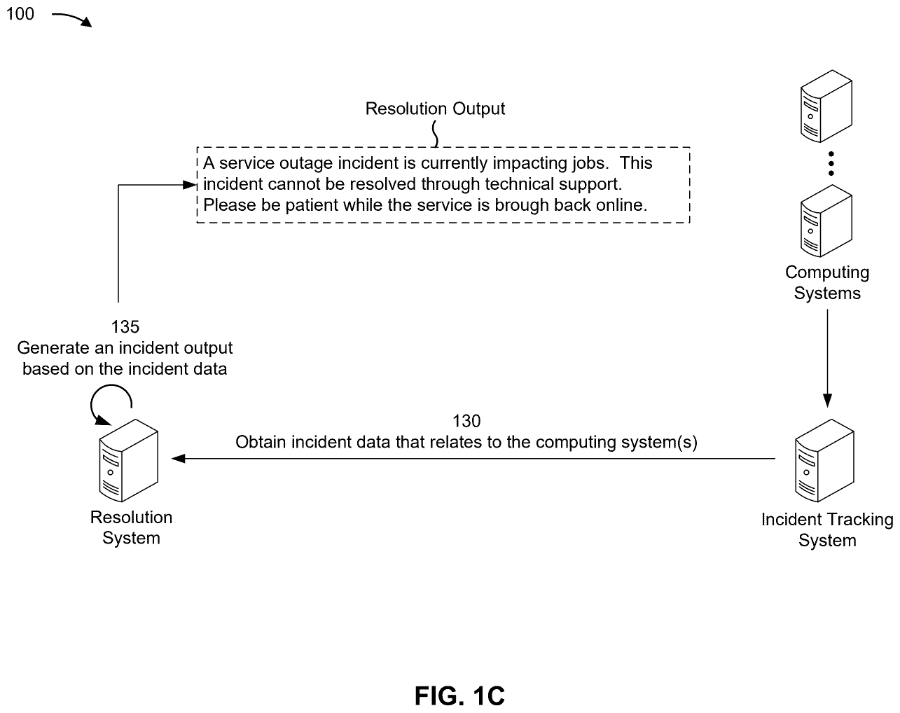

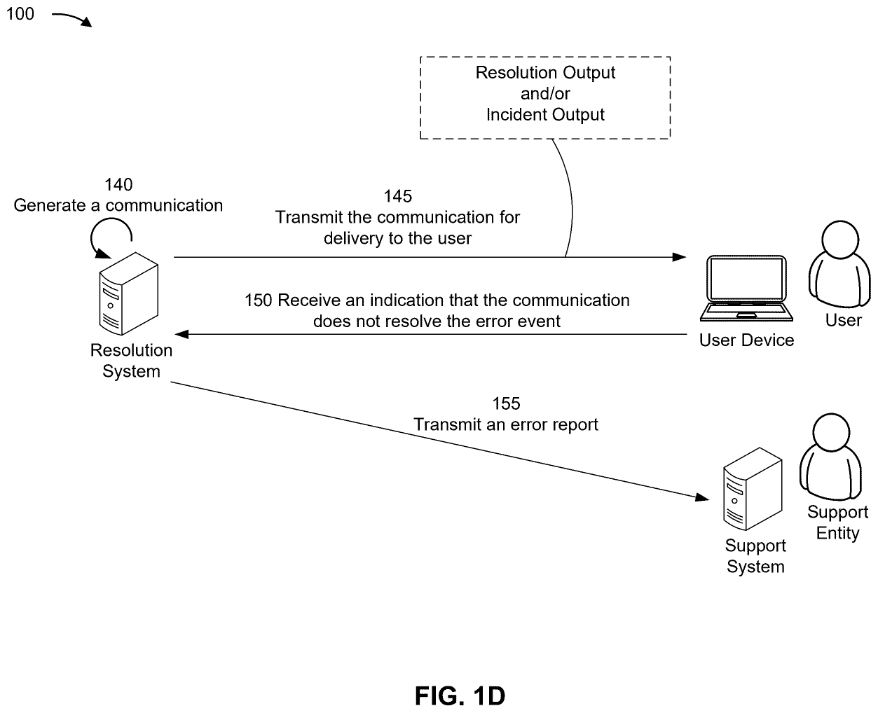

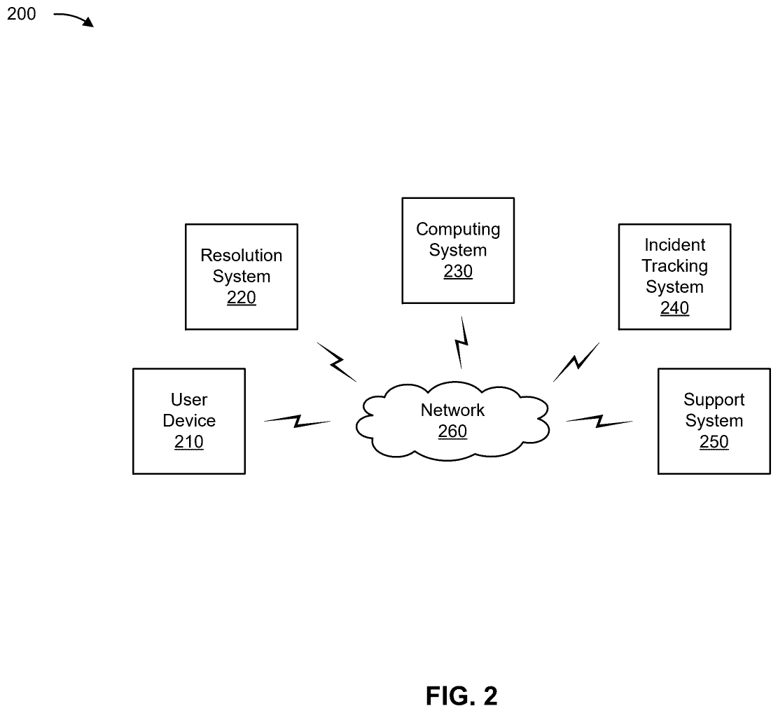

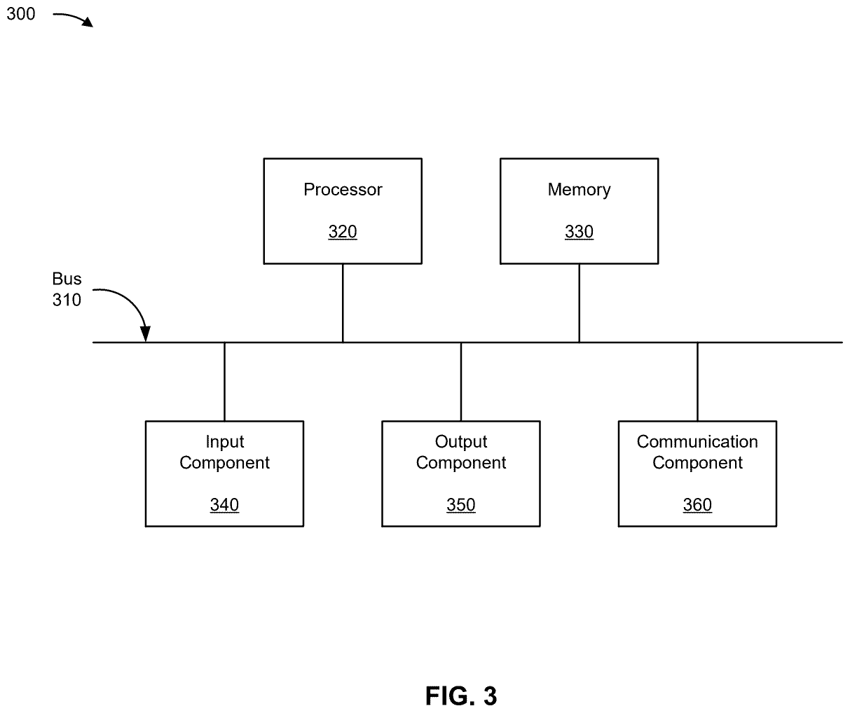

FIGS. 1A-1D are diagrams of an example 100 associated with proactive error resolution for an executing job. As shown in FIGS. 1A-1D, example 100 includes a user device, a resolution system, one or more computing systems, one or more incident tracking systems, and a support system. These devices are described in more detail in connection with FIGS. 2 and 3.

The user device may be associated with a user. The user device may implement a platform (e.g., a framework or environment that provides components and services for developing, deploying, and/or managing software), or may be configured to access the platform (e.g., which may be implemented in a cloud computing system). In some implementations, the platform may be a CI/CD platform (e.g., a platform for implementing CI/CD pipelines, such as for integrating code changes, building software artifacts, testing applications, and deploying applications to one or more environments).

The platform may use the one or more computing systems (e.g., multiple computing systems) in connection with executing jobs. For example, in connection with execution of a job, the platform may provide instructions, data, and/or files to a computing system, may receive instructions, data, and/or files from a computing system, or the like. In some implementations, the computing systems may include a computing system on which the platform is implemented and/or may include a computing system that is separate from a computing system that implements the platform (e.g., the computing systems may be external systems). In some implementations, the computing systems may include one or more version control systems and/or one or more cloud computing systems, among other examples. For example, the platform may use a version control system to integrate code changes and/or build software artifacts. As another example, the platform may use a cloud computing system to deploy an application to a cloud computing environment. The incident tracking systems may monitor and/or record data relating to incidents impacting the computing systems.

The resolution system may integrate with the platform to provide real-time monitoring of operations of the platform during execution of a job. In some implementations, the resolution system may periodically query an application programming interface (API) of the platform to fetch information about an ongoing job. Additionally, or alternatively, the resolution system may establish a webhook endpoint to receive notifications from the platform during execution of a job. The support system may provide a support channel through which users can receive technical support from a support entity (e.g., support personnel or a chatbot). The support system may implement a ticketing system, a chat system, a voice calling system, a video calling system, a call distribution system, or the like.

As shown in FIG. 1A, and by reference number 105, the user device may initiate an execution of a job (e.g., one or more jobs) on the platform. For example, the job may be user-initiated by the user. In some implementations, the execution of the job is a build process for an application on a CI/CD platform. As described herein, the platform may use (e.g., communicate instructions, data, and/or files with) the computing system(s) in connection with execution of the job. In response to the initiation of the execution of the job, the resolution system may begin monitoring (e.g., in real time) the execution of the job (e.g., monitoring a CI/CD pipeline in runtime). Accordingly, based on this monitoring, operations of the resolution system may be performed proactively, in the absence of a request (e.g., a request to provide support) or an indication (e.g., an indication of an error) from the user.

As shown by reference number 110, in connection with monitoring the execution of the job, the resolution system may obtain (e.g., retrieve) one or more logs (e.g., log files) that relate to the execution of the job. For example, the logs may be generated by the platform during the execution of the job. Accordingly, the resolution system may obtain the logs during the execution of the job (e.g., each time the logs are updated, in response to a status change for the execution of the job, periodically, or the like). However, in some examples, the resolution system may obtain the logs after the execution of the job has completed (e.g., successfully or in failure). In some implementations, the resolution system may request the logs via an API endpoint, and the resolution system may receive an API response indicating the logs. Additionally, or alternatively, the resolution system may retrieve the logs from a storage location. Additionally, or alternatively, the resolution system may establish a log streaming connection with the platform, and the resolution system may stream log messages as they are generated by the platform during the execution of the job.

As shown by reference number 115, the resolution system may process the logs to identify whether an entry in the logs indicates an error event for the job. In this way, the resolution system may make a context-aware decision as to whether the user is in need of support. An error event may relate to a compilation error, a configuration error, a timeout error (e.g., a deployment timeout error), an incompatibility or conflict error, an insufficient permissions error, an authentication error, a resource constraint error (e.g., insufficient memory or disk space), a network error (e.g., a connection timeout), and/or a security violation error, among other examples. In some examples, to process the logs, the resolution system may scan a plurality of entries indicated in the logs, and determine, for each of the entries, whether an error is indicated by that entry.

In some implementations, the resolution system may identify an entry relating to an error event based on identifying an error code or error-related text in the entry. For example, while scanning the entries, the resolution system may compare the text of each entry against a list of error codes and/or a list of error-related terminology (e.g., “error,” “failure,” “exception,” or the like). Additionally, or alternatively, the resolution system may identify an entry relating to an error event based on identifying formats or patterns that match common error messages. For example, the resolution system may apply a regular expression (regex) to the entries to extract one or more entries relating to error events. Additionally, or alternatively, the resolution system may identify an entry relating to an error event by processing the log using a machine learning classification model. For example, the machine learning classification model may be trained to classify entries as error events or non-error events, or to classify an entry as a particular type of event. Additionally, or alternatively, the resolution system may identify an entry relating to an error event by applying an anomaly detection algorithm to the logs. For example, the anomaly detection algorithm may be configured to identify deviations from normal log patterns, such as unusual patterns of events.

In some implementations, as shown in FIG. 1B, and by reference number 120, the resolution system may cause storing (e.g., in a database) of training data for a machine learning language model. For example, the resolution system may transmit the training data to a database system for storage. The training data may be in accordance with the logs (e.g., the training data may include the logs or may include information derived from the logs). In some implementations, the training data may indicate event classifications for one or more entries in the logs. The classifications may be derived from the machine learning classification model, as described herein, or provided by a subject matter expert. In some implementations, the training data may additionally or alternatively include documentation for the platform, transcripts of historical support interactions involving the user or other users, and/or summaries of historical support interactions involving the user or other users, among other examples. The training data may be used for training, retraining, or fine tuning of the machine learning language model. For example, the machine learning language model may be fine tuned with respect to the platform. Alternatively, the machine learning language model may be a general machine learning language model. The machine learning language model may be a deep learning model, an artificial neural network model, a transformer model, or the like.

As shown by reference number 125, the resolution system may determine a resolution output relating to the error event. For example, the resolution system may input context information to the machine learning language model to obtain a resolution output. For example, the resolution system may utilize the machine learning language model to obtain the resolution output responsive to identifying an entry in the logs that indicates an error event. The context information may include the logs and/or event information derived from the entry. For example, the event information may identify the entry and/or an event type associated with the entry (e.g., derived from the machine learning classification model, as described herein). In some implementations, the context information may further include support information (e.g., a transcript and/or a summary) relating to one or more support interactions between the user and a support entity, such as a human or a chatbot (e.g., if the user sought technical support at one or more points during the execution of the job).

Using the context information as an input, the machine learning language model may provide the resolution output. For example, the machine learning language model may identify a solution for the error event, and generate the resolution output that indicates the solution for the error event. The resolution output may include text (e.g., natural language text) that indicates the solution, or another type of resolution, for the error event. For example, the resolution output may indicate one or more actions that the user can take to resolve the error event, one or more updates that the user can make (e.g., to code, configurations, or the like) to resolve the error event, and/or one or more troubleshooting steps that the user can perform, among other examples.

As shown in FIG. 1C, and by reference number 130, the resolution system may obtain (e.g., retrieve) incident data that relates to the computing system(s). The incident data may indicate whether an incident impacting the computing system(s) has been detected. Moreover, the incident data may relate to a time period that encompasses the execution of the job. An incident impacting the computing system(s) may be a service outage of a service (e.g., an artifact storage service, a build execution service, or the like) implemented on a computing system, downtime associated with a computing system, network connectivity issues between the resolution system and a computing system, and/or loss or corruption of data stored by a computing system, among other examples. Accordingly, an incident impacting the computing system(s) may be a cause of the error event that was logged, in which case, there may be nothing that can be done by the user to resolve the error event until the incident has been resolved.

The resolution system may obtain the incident data from the incident tracking system(s). For example, the resolution system may obtain incident data relating to a first computing system from a first incident tracking system (e.g., the first incident tracking system may be provided by an entity that also maintains or controls the first computing system), may obtain incident data relating to a second computing system from a second incident tracking system (e.g., the second incident tracking system may be provided by an entity that also maintains or controls the second computing system), and so forth. Alternatively, the resolution system may obtain incident data relating to multiple computing systems from a single incident tracking system. In some implementations, a computing system may be monitored by an automated process on an incident tracking system and/or may be monitored by monitoring personnel. Detected incidents may be recorded (e.g., in a log) to the incident tracking system, may be posted in an incident reporting channel (e.g., a webpage post or a social media post), may be added to an incident event stream, and/or may be pushed in a notification to one or more other systems (e.g., the resolution system).

In some implementations, the resolution system may obtain the incident data by transmitting to the incident tracking system an API request for the incident data, and receiving from the incident tracking system an API response indicating the incident data. Additionally, or alternatively, the resolution system may establish a webhook endpoint to receive the incident data from the incident tracking system. Additionally, or alternatively, the resolution system may monitor (e.g., scrape, parse, process, or the like) an incident reporting channel (e.g., a web page or a social media account) for new incident posts, or may monitor an incident event stream for new incident events.

The resolution system may obtain the incident data responsive to identifying the entry in the logs that indicates the error event. In particular, the resolution system may obtain the incident data in parallel with obtaining the resolution output from the machine learning language model (as described at reference number 125). Alternatively, the resolution system may obtain the incident data before obtaining the resolution output from the machine learning language model, and the resolution system may forgo obtaining the resolution output from the machine learning language model if the incident data indicates an incident that is causing the error event.

As shown by reference number 135, the resolution system may generate an incident output based on the incident data. For example, the resolution system may generate the incident output responsive to the incident data indicating that an incident impacting the computing system(s) has been detected. The incident output may indicate a type of the incident, a time of the incident, an expected amount of time for the incident to be resolved, and/or an explanation of the incident, among other examples. Furthermore, the incident output may indicate that the incident is the cause of the error event and/or may instruct the user to refrain from performing resolution actions for the error event due to the incident being the cause of the error event. In some implementations, the resolution system may use the machine learning language model or a different machine learning language model to generate the incident output.

As shown in FIG. 1D, and by reference number 140, the resolution system may generate a communication that is for the user. The communication may include the resolution output and/or the incident output. For example, the communication may include the resolution output and/or the incident output in accordance with whether the incident data indicates the incident. The communication may include the incident output (e.g., with or without the resolution output) in accordance with the incident data indicating the incident. Alternatively, the communication may include the resolution output, without the incident output, in accordance with the incident data not indicating any incident (in which case the incident output is not generated in connection with reference number 135). The communication may be a chat communication, an email communication, a text communication, or a phone communication, among other examples.

As shown by reference number 145, the resolution system may transmit the communication for delivery to the user (e.g., via a notification service). For example, the user device may receive the communication transmitted by the resolution system. The communication may be delivered to the user as a chat message (e.g., a direct message), a text message, an email message, or an automated phone call, among other examples. The resolution system may transmit the communication proactively, in the absence of a request for support made by the user. By proactively notifying the user of a resolution for the error event and/or of a broader incident that would make resolution attempts futile, the resolution system conserves computing resources and/or network resources that would otherwise be used in connection with a lengthy and inefficient support session between the user device and a support device to engage in error diagnosis and/or troubleshooting.

As shown by reference number 150, the resolution system may receive an indication that the communication does not resolve the error event for the user (e.g., the resolution output and/or the incident output do not provide a resolution/explanation for the error event). In some implementations, the communication may include an input element (e.g., a button, a link, or the like), that when activated by the user, triggers a transmission of the indication to the resolution system. As shown by reference number 155, responsive to the indication, the resolution system may transmit an error report, relating to the error event, to the support system. The error report may include the logs, the entry from the logs, and/or the event information, among other examples. Moreover, the resolution system may cause opening of a ticket relating to the error event, or may cause initiation of a voice or video call between the user device and the support system, among other examples.

In some implementations, the resolution system may obtain historical data (e.g., in historical logs) relating to one or more previous jobs executed by the user in the platform. The historical data may indicate whether the previous jobs succeeded or failed, execution durations of the previous jobs, resource usage by the previous jobs, or the like. In some implementations, the resolution system may generate trend data in accordance with the historical data. For example, the trend data may indicate whether the user's jobs are increasingly succeeding or increasingly failing, whether execution durations of the user's jobs are increasing or decreasing, whether resource usage of the user's jobs is increasing or decreasing, or the like. Accordingly, the trend data may indicate factors (e.g., other than error events) that are leading to the success or failure of the user's jobs. In some implementations, the resolution system may transmit the trend data for delivery to the user, in a similar manner as described elsewhere herein.

In some implementations, the resolution system may determine, using the historical data, whether a survey is to be provided to the user. For example, the resolution system may determine, using the historical data, an appropriate timing for sending the survey to the user. As an example, if the user's jobs have experienced a series of successful executions or a series of failed executions (e.g., a quantity of which satisfies a threshold), then the resolution system may determine that the survey is to be proved to the user. In some implementations, based on a determination that the survey is to be provided to the user, the resolution system may transmit the survey for delivery to the user, in a similar manner as described elsewhere herein. The survey may relate to the user's usage of the platform (e.g., in connection with successful job executions or failed job executions) or may relate to communications that the user has received from the resolution system (e.g., whether those communications resolved previous errors). In some implementations, user surveys may be used to train, retrain, or fine tune the machine learning language model.

The proactive communications described herein conserve computing resources and/or network resources that would otherwise be used in connection with a lengthy and inefficient support session between the user device and the support device to engage in error diagnosis and/or troubleshooting. Moreover, by proactively notifying the user of a resolution for the error event, the resolution system enables errors to be resolved faster and more efficiently, thereby improving the performance of an execution of the job, improving an availability or uptime of downstream services or systems relating to the job, and/or conserving computing resources of a system that implements the platform (e.g., by reducing a number of attempts to execute the job and/or reducing troubleshooting operations).

As indicated above, FIGS. 1A-1D are provided as an example. Other examples may differ from what is described with regard to FIGS. 1A-1D.

FIG. 2 is a diagram of an example environment 200 in which systems and/or methods described herein may be implemented. As shown in FIG. 2, environment 200 may include a user device 210, a resolution system 220, a computing system 230, an incident tracking system 240, a support system 250, and a network 260. Devices of environment 200 may interconnect via wired connections, wireless connections, or a combination of wired and wireless connections.

The user device 210 may include one or more devices capable of receiving, generating, storing, processing, and/or providing information associated with initiating an execution of a job and proactive error resolution for an executing job, as described elsewhere herein. The user device 210 may include a communication device and/or a computing device. For example, the user device 210 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The resolution system 220 may include one or more devices capable of receiving, generating, storing, processing, providing, and/or routing information associated with proactive error resolution for an executing job, as described elsewhere herein. The resolution system 220 may include a communication device and/or a computing device. For example, the resolution system 220 may include a server, such as an application server, a client server, a web server, a database server, a host server, a proxy server, a virtual server (e.g., executing on computing hardware), or a server in a cloud computing system. In some implementations, the resolution system 220 may include computing hardware used in a cloud computing environment.

The computing system 230 may include one or more devices capable of receiving, generating, storing, processing, providing, and/or routing information associated with an execution of a job in a platform, as described elsewhere herein. The computing system 230 may include a communication device and/or a computing device. For example, the computing system 230 may include a server, such as an application server, a client server, a web server, a database server, a host server, a proxy server, a virtual server (e.g., executing on computing hardware), or a server in a cloud computing system. In some implementations, the computing system 230 may include computing hardware used in a cloud computing environment.

The incident tracking system 240 may include one or more devices capable of receiving, generating, storing, processing, providing, and/or routing information associated with incidents (e.g., production incidents) impacting the computing system 230, as described elsewhere herein. The incident tracking system 240 may include a communication device and/or a computing device. For example, the incident tracking system 240 may include a server, such as an application server, a client server, a web server, a database server, a host server, a proxy server, a virtual server (e.g., executing on computing hardware), or a server in a cloud computing system. In some implementations, the incident tracking system 240 may include computing hardware used in a cloud computing environment.

The support system 250 may include one or more devices capable of receiving, generating, storing, processing, providing, and/or routing information associated with technical support services, as described elsewhere herein. The support system 250 may include a communication device and/or a computing device. For example, the support system 250 may include a server, such as an application server, a client server, a web server, a database server, a host server, a proxy server, a virtual server (e.g., executing on computing hardware), or a server in a cloud computing system. In some implementations, the support system 250 may include computing hardware used in a cloud computing environment.

The network 260 may include one or more wired and/or wireless networks. For example, the network 260 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 260 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with proactive error resolution for an executing job. The device 300 may correspond to user device 210, resolution system 220, computing system 230, incident tracking system 240, and/or support system 250. In some implementations, user device 210, resolution system 220, computing system 230, incident tracking system 240, and/or support system 250 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

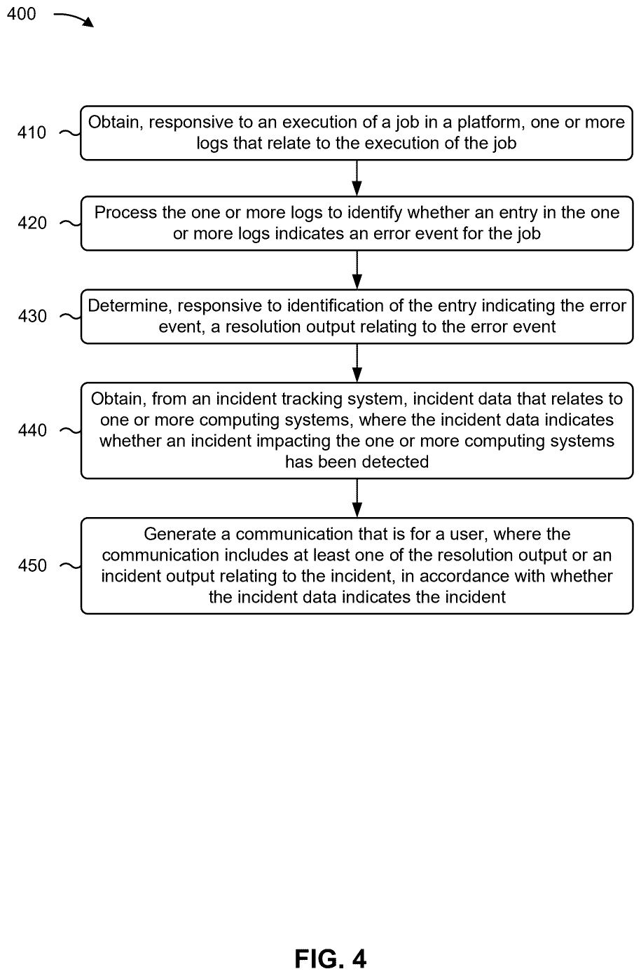

FIG. 4 is a flowchart of an example process 400 associated with proactive error resolution for an executing job. In some implementations, one or more process blocks of FIG. 4 may be performed by the resolution system 220. In some implementations, one or more process blocks of FIG. 4 may be performed by another device or a group of devices separate from or including the resolution system 220, such as the user device 210, the computing system 230, the incident tracking system 240, and/or the support system 250. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include obtaining, responsive to an execution of a job in a platform, one or more logs that relate to the execution of the job (block 410). For example, the resolution system 220 (e.g., using processor 320, memory 330, and/or communication component 360) may obtain, responsive to an execution of a job in a platform, one or more logs that relate to the execution of the job, as described above in connection with reference number 110 of FIG. 1A. As an example, the logs may be generated by the platform during the execution of the job, and the logs may be obtained during the execution of the job. In some implementations, the platform uses one or more computing systems in connection with the execution of the job. In some implementations, the job is user-initiated by a user.

As further shown in FIG. 4, process 400 may include processing the one or more logs to identify whether an entry in the one or more logs indicates an error event for the job (block 420). For example, the resolution system 220 (e.g., using processor 320 and/or memory 330) may process the one or more logs to identify whether an entry in the one or more logs indicates an error event for the job, as described above in connection with reference number 115 of FIG. 1A. As an example, an error event may relate to a compilation error, a configuration error, a timeout error (e.g., a deployment timeout error), an incompatibility or conflict error, an insufficient permissions error, an authentication error, a resource constraint error (e.g., insufficient memory or disk space), a network error (e.g., a connection timeout), and/or a security violation error, among other examples.

As further shown in FIG. 4, process 400 may include determining, responsive to identification of the entry indicating the error event, a resolution output relating to the error event (block 430). For example, the resolution system 220 (e.g., using processor 320, memory 330, and/or communication component 360) may determine, responsive to identification of the entry indicating the error event, a resolution output relating to the error event, as described above in connection with reference number 125 of FIG. 1B. As an example, context information may be input to a machine learning language model to obtain the resolution output.

As further shown in FIG. 4, process 400 may include obtaining, from an incident tracking system, incident data that relates to the one or more computing systems, where the incident data indicates whether an incident impacting the one or more computing systems has been detected (block 440). For example, the resolution system 220 (e.g., using processor 320, memory 330, and/or communication component 360) may obtain, from an incident tracking system, incident data that relates to the one or more computing systems, as described above in connection with reference number 130 of FIG. 1C. As an example, an incident impacting the computing system(s) may be a service outage of a service (e.g., an artifact storage service, a build execution service, or the like) implemented on a computing system, downtime associated with a computing system, network connectivity issues between the resolution system and a computing system, and/or loss or corruption of data stored by a computing system, among other examples.

As further shown in FIG. 4, process 400 may include generating a communication that is for the user, where the communication includes at least one of the resolution output or an incident output relating to the incident, in accordance with whether the incident data indicates the incident (block 450). For example, the resolution system 220 (e.g., using processor 320 and/or memory 330) may generate a communication that is for the user, as described above in connection with reference number 140 of FIG. 1D. As an example, the communication may include the incident output (e.g., with or without the resolution output) in accordance with the incident data indicating the incident, or the communication may include the resolution output, without the incident output, in accordance with the incident data not indicating any incident.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1D. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for proactive error resolution, the system comprising:
one or more memories; and
one or more processors, communicatively coupled to the one or more memories, configured to:
obtain one or more logs that relate to a build process for an application in a continuous integration/continuous deployment (CI/CD) platform,
wherein the one or more logs are generated by the CI/CD platform,
wherein the CI/CD platform uses one or more computing systems in connection with the build process, and
wherein the build process is user-initiated by a user;
process the one or more logs to identify whether an entry in the one or more logs indicates an error event for the build process;
input, responsive to identification of the entry indicating the error event, context information to a machine learning language model to obtain a resolution output,
wherein the context information includes the one or more logs and event information derived from the entry;
obtain, from an incident tracking system and responsive to identification of the entry indicating the error event, incident data that relates to the one or more computing systems,
wherein the incident data indicates whether an incident impacting the one or more computing systems has been detected; and
generate a communication that is for the user,
wherein the communication includes at least one of the resolution output or an incident output relating to the incident, in accordance with whether the incident data indicates the incident.

2. The system of claim 1, wherein the context information further includes support information relating to one or more interactions between the user and a support entity.

3. The system of claim 1, wherein the one or more processors, to obtain the one or more logs, are configured to obtain the one or more logs during the build process.

4. The system of claim 1, wherein the one or more processors are further configured to:
transmit the communication for delivery to the user by at least one of:
a chat message,
a text message,
an email message, or
an automated phone call.

5. The system of claim 1, wherein the one or more processors, to process the one or more logs, are configured to:
scan a plurality of entries indicated in the one or more logs; and
determine, for each of the plurality of entries, whether an error is indicated by that entry.

6. The system of claim 1, wherein the one or more processors are further configured to:
cause storing of training data for the machine learning language model in accordance with the one or more logs.

7. The system of claim 1, wherein the one or more processors are further configured to:
receive an indication that the communication does not resolve the error event for the user; and
transmit, responsive to the indication and to a support system, an error report that includes at least one of:
the one or more logs,
the event information, or
the entry.

8. The system of claim 1, wherein the communication includes the incident output in accordance with the incident data indicating the incident.

9. The system of claim 1, wherein the communication includes the resolution output without the incident output in accordance with the incident data not indicating any incident.

10. A method of proactive error resolution, comprising:
obtaining, responsive to an execution of a job in a platform, one or more logs that relate to the execution of the job,
wherein the one or more logs are generated by the platform, and
wherein the platform uses one or more computing systems in connection with the execution of the job;
processing the one or more logs to identify whether an entry in the one or more logs indicates an error event for the job;
determining, responsive to identification of the entry indicating the error event, a resolution output relating to the error event;
obtaining, from an incident tracking system, incident data that relates to the one or more computing systems,
wherein the incident data indicates whether an incident impacting the one or more computing systems has been detected; and
generating a communication that includes at least one of the resolution output or an incident output relating to the incident, in accordance with whether the incident data indicates the incident.

11. The method of claim 10, wherein determining the resolution output comprises:
inputting context information to a machine learning language model to obtain the resolution output,
wherein the context information includes event information derived from the entry.

12. The method of claim 11, wherein the event information further includes the one or more logs.

13. The method of claim 10, wherein the one or more computing systems include at least one of:
one or more version control systems, or
one or more cloud computing systems.

14. The method of claim 10, further comprising:
obtaining historical data relating to one or more previous jobs executed in the platform;
generating trend data in accordance with the historical data; and
transmitting the trend data.

15. The method of claim 10, further comprising:
obtaining historical data relating to one or more previous jobs executed in the platform;
determining, using the historical data, whether a survey is to be provided; and
transmitting, based on a determination that the survey is to be provided, the survey.

16. A non-transitory computer-readable medium storing a set of instructions for proactive error resolution, the set of instructions comprising:
one or more instructions that, when executed by one or more processors of a device, cause the device to:
obtain one or more logs that relate to an execution of a job in a platform,
wherein the one or more logs are generated by the platform,
wherein the platform uses one or more computing systems in connection with the execution of the job, and
wherein the job is user-initiated by a user;
process the one or more logs to identify whether an entry in the one or more logs indicates an error event for the job;
input, responsive to identification of the entry indicating the error event, context information to a machine learning language model to obtain a resolution output,
wherein the context information includes event information derived from
the entry;
generate a communication that includes the resolution output; and
transmit the communication for delivery to the user by at least one of a chat message, a text message, an email message, or an automated phone call.

17. The non-transitory computer-readable medium of claim 16, wherein the one or more instructions, that cause the device to transmit the communication, cause the device to transmit the communication proactively, in the absence of a request for support made by the user.

18. The non-transitory computer-readable medium of claim 16, wherein the event information further includes the one or more logs.

19. The non-transitory computer-readable medium of claim 16, wherein the platform is a continuous integration/continuous deployment (CI/CD) platform, and
wherein the execution of the job is a build process for an application.

20. The non-transitory computer-readable medium of claim 16, wherein the one or more computing systems comprise multiple computing systems.
